(19) United States
(12) Patent Application Publication
(10) Pub. No.: US 2014/0286188 A1
(43) Pub. Date: Sep. 25, 2014

(54) METHOD AND APPARATUS FOR MEASURING INTERFERENCE IN WIRELESS COMMUNICATION SYSTEM

(71) Applicant: LG ELECTRONICS INC., Seoul (KR)

(72) Inventors: Ji Won Kang, Anyang-si (KR); Jin Young Chun, Anyang-si (KR); Ki Tae Kim, Anyang-si (KR); Su Nam Kim, Anyang-si (KR); Bin Chul Ihm, Anyang-si (KR); Sung Ho Park, Anyang-si (KR)

(73) Assignee: LG ELECTRONICS INC., Seoul (KR)

(21) Appl. No.: 14/354,891

(22) PCT Filed: Oct. 30, 2012
(86) PCT No.: PCT/KR2012/008974

§ 371 Date: Apr. 28, 2014

Related U.S. Application Data
(60) Provisional application No. 61/553,267, filed on Oct. 31, 2011.

(51) Int. Cl. H04W 24/10

(52) U.S. Cl. CPC H04W 24/10
USPC 370/252

(57) ABSTRACT

Provided is a method for measuring interference by a user equipment (UE) in a multi-node system comprising inside a cell a base station and a plurality of nodes that are controlled by the base station, and the user equipment for same. The method comprises: receiving from the base station a node set-specific interference measurement region (NSIR) setting message from a node set that comprises a portion of the nodes from the plurality of nodes; and measuring the interference in a resource region that is indicated by the NSIR setting message, wherein the NSIR setting message is characterized by all of the nodes in the node set comprising information for setting an interference measurement region for transmitting a zero-power channel state information (CSI) reference signal (RS).

### BACKGROUND OF THE INVENTION

1. Field of the Invention

The present invention relates to wireless communication and, more particularly, to a method and apparatus for measuring interference in a wireless communication system.

2. Related Art

The next-generation multimedia wireless communication systems now being actively researched are required to process and send various pieces of information, such as video and wireless data out of the early voice-centered service. The 4^{th} generation wireless communication systems being developed which are subsequent to the current 3^{rd} generation wireless communication systems are aiming at supporting high-speed data service of downlink 1 Gigabit per second (Gbps) and of uplink 500 Megabits per second (Mbps). An object of a wireless communication system is to enable a number of users to perform reliable communication irrespective of their locations and mobility. However, a wireless channel has abnormal characteristics, such as a path loss, noise, a fading phenomenon attributable to multi-path, Inter-Symbol Interference (ISI), and the Doppler effect resulting from the mobility of a terminal. A variety of techniques are being developed in order to overcome the abnormal characteristics of wireless channels and to increase the reliability of wireless communication.

Meanwhile, the amount of data required for a cellular network is rapidly increased due to the introduction of Machine-To-Machine (M2M) communication and the appearance and spread of various devices, such as smart phones and tablet PCs. In order to satisfy a large amount of data required, various technologies are being developed. Research is being carried out on Carrier Aggregation (CA) technology for efficiently using more frequency bands, Cognitive Radio (CR) technology, etc. Furthermore, multiple antenna technology, multiple base station cooperation technology, etc. for increasing a data capacity within a limited frequency band are being researched. That is, as a result, a wireless communication system will evolve into the direction toward a higher density of nodes that may be accessed by a user nearby. The performance of a wireless communication system having a high density of nodes may be further improved by cooperation between the nodes. That is, a wireless communication system in which nodes cooperate with each other has more excellent performance than a wireless communication system in which each of nodes operates as an independent Base Station (BS), an Advanced BS (ABS), a Node-B (NB), an eNode-B (eNB), or an Access Point (AP).

In order to improve the performance of a wireless communication system, a Distributed Multi-Node System (DMNS) (hereinafter referred to as a multi-node system) including a plurality of nodes within a cell may be applied. The multi-node system may include a Distributed Antenna System (DAS), a Radio Remote Head (RRH), etc. Furthermore, a standardization task for applying various Multiple-Input Multiple-Output (MIMO) scheme and cooperation communication schemes that have already been developed or that may be applied in the future to the multi-node system is in progress.

There is a need for a method for efficiently measuring, by a terminal, interference in a multi-node system.

### SUMMARY OF THE INVENTION

An object of the present invention is to provide a method and apparatus for measuring interference in a wireless communication system.

A method of measuring, by User Equipment (UE), interference in a multi-node system comprising a plurality of nodes, provided in an aspect, includes receiving a Node set-Specific Interference measurement Region (NSIR) configuration message from a base station in a node set comprising some of the plurality of nodes, and measuring interference in a resource region indicated by the NSIR configuration message, wherein the NSIR configuration message comprises information for configuring an interference measurement region in which all the nodes within the node set send a zero power Channel State Information (CSI) Reference Signal (RS).

User Equipment (UE) measuring interference in a multi-node system comprising a plurality of nodes, provided in another aspect, includes a Radio Frequency (RF) unit sending or receiving radio signals; and a processor connected to the RF unit, wherein the processor receives a Node set-Specific Interference measurement Region (NSIR) configuration message from a base station in a node set comprising some of the plurality of nodes and measures interference in a resource region indicated by the NSIR configuration message, and the NSIR configuration message comprises information for configuring an interference measurement region in which all the nodes within the node set send a zero power Channel State Information (CSI) Reference Signal (RS).

In a multi-node system, system resources can be efficiently used because the amount of resources on which muting has to be performed for interference measurement can be reduced.

### BRIEF DESCRIPTION OF THE DRAWINGS

FIG. 1 is a wireless communication system.

FIG. 2 shows the structure of a radio frame in 3GPP LTE.

FIG. 3 shows an example of a resource grid for a single downlink slot.

FIG. 4 shows the structure of a DL subframe.

FIG. 5 shows the structure of an UL subframe.

FIG. 6 shows an example of a multi-node system.

FIGS. 7 to 9 show examples of an RB to which a CRS is mapped.

FIG. 10 shows an example of an RB to which a CSI-RS is mapped.

FIG. 11 shows the concept of CSI feedback.

FIG. 12 shows an example in which muting resources for interference measurement are configured.

FIG. 13 shows the assignment of muting resources in accordance with an embodiment of the present invention.

FIG. 14 shows an interference measurement method of UE in accordance with an embodiment of the present invention.

FIG. 15 is a block diagram of a wireless communication system in which an embodiment of the present invention is implemented.

### DESCRIPTION OF EXEMPLARY EMBODIMENTS

The following technology may be used in a variety of wireless communication systems, such as Code Division Multiple Access (CDMA), Frequency Division Multiple Access (FDMA), Time Division Multiple Access (TDMA), Orthogonal Frequency Division Multiple Access (OFDMA), and Single Carrier Frequency Division Multiple Access (SC-FDMA). CDMA may be implemented using radio technology, such as Universal Terrestrial Radio Access (UTRA) or CDMA2000. TDMA may be implemented using radio technology, such as Global System for Mobile communications (GSM)/General Packet Radio Service (GPRS)/Enhanced Data Rates for GSM Evolution (EDGE). OFDMA may be implemented using radio technology, such as Institute of Electrical and Electronics Engineers (IEEE) 802.11 (Wi-Fi), IEEE 802.16 (WiMAX), IEEE 802.20, or Evolved-UTRA (E-UTRA). IEEE 802.16m is the evolution of IEEE 802.16e, and it provides backward compatibility with systems based on IEEE 802.16e. UTRA is part of a Universal Mobile Telecommunications System (UMTS). 3^{rd} Generation Partnership Project (3GPP) Long Term Evolution (LTE) is part of an Evolved UMTS (E-UMTS) using Evolved-UMTS Terrestrial Radio Access (E-UTRA), and 3GPP LTE adopts OFDMA in downlink and adopts SC-FDMA in uplink. LTE-Advance (LTE-A) is the evolution of 3GPP LTE.

In order to clarify a description, LTE-A is chiefly described, but the technical spirit of the present invention is not limited thereto.

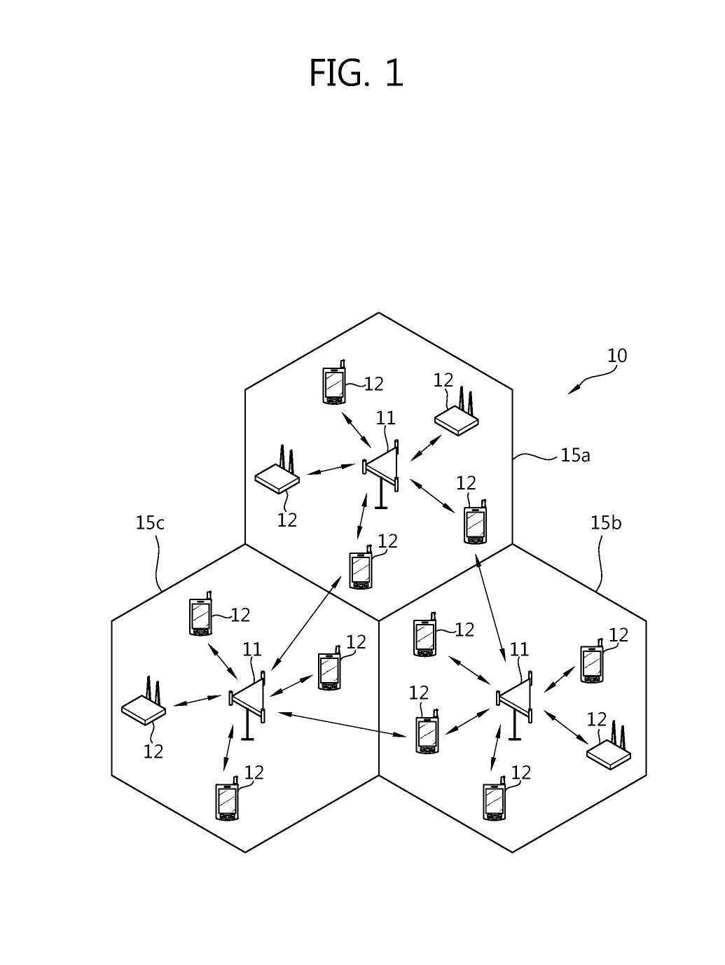

FIG. 1 is a wireless communication system.

The wireless communication system 10 includes one or more Base Stations (BSs) 11. The BSs 11 provide communication service to respective geographical areas (commonly called cells) 15a, 15b, and 15c. The cell may be divided into a plurality of regions (called sectors). User Equipment (UE) 12 may be fixed or mobile and also be called another terminology, such as a Mobile Station (MS), a Mobile Terminal (MT), a User Terminal (UT), a Subscriber Station (SS), a wireless device, a Personal Digital Assistant (PDA), a wireless modem, or a handheld device. The BS 11 commonly refers to a fixed station that communicates with the MSs 12, and the BS may also be called another terminology, such as an evolved NodeB (eNB), a Base Transceiver System (BTS), or an access point.

In general, UE belongs to a single cell, and a cell to which UE belongs is called a serving cell. A BS that provides a serving cell with communication service is called a serving BS. Since a wireless communication system is a cellular system, another cell neighboring a serving cell is present. Another cell neighboring a serving cell is called a neighbor cell. A BS that provides a neighbor cell with communication service is called a neighbor BS. A serving cell and a neighbor cell are relatively determined on the basis of UE.

This technology may be used in downlink or uplink. In general, downlink refers to communication from the BS 11 to the UE 12, and uplink refers to communication from the UE 12 to the BS 11. In downlink, a transmitter may be part of the BS 11, and a receiver may be part of the UE 12. In uplink, a transmitter may be part of the UE 12, and a receiver may be part of the BS 11.

The wireless communication system may be any one of a Multiple-Input Multiple-Output (MIMO) system, a Multiple-Input Single-Output (MISO) system, a Single-Input Single-Output (SISO) system, and a Single-Input Multiple-Output (SIMO) system. An MIMO system uses a plurality of transmit antennas and a plurality of receive antennas. An MISO system uses a plurality of transmit antennas and one receive antenna. An SISO system uses one transmit antenna and one receive antenna. An SIMO system uses one transmit antenna and a plurality of receive antennas. Hereinafter, a transmit antenna means a physical or logical antenna used to send one signal or stream, and a receive antenna means a physical or logical antenna used to receive one signal or stream.

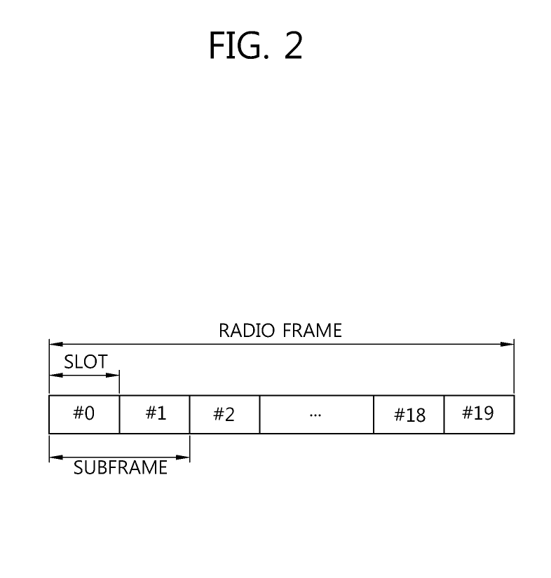

FIG. 2 shows the structure of a radio frame in 3 GPP LTE.

For the structure of the radio frame, reference may be made to Paragraph 5 of a 3rd Generation Partnership Project (3GPP) TS 36.211 V10.3.0 (2011 September) “Technical Specification Group Radio Access Network; Evolved Universal Terrestrial Radio Access (E-UTRA); Physical channels and modulation (Release 10)”. Referring to FIG. 2, the radio frame includes 10 subframes, and one subframe includes two slots. The slots within the radio frame are assigned slot numbers from #0 to #19. The time taken for one subframe to be transmitted is called a Transmission Time Interval (TTI). The TTI may be a scheduling unit for data transmission. For example, the length of one radio frame may be 10 ms, the length of one subframe may be 1 ms, and the length of one slot may be 0.5 ms.

A single slot includes a plurality of Orthogonal Frequency Division Multiplexing (OFDM) symbols in a time domain and includes a plurality of subcarriers in a frequency domain. The OFDM symbol is for representing a single symbol period because 3GPP LTE uses OFDMA in downlink and may be called another terminology depending on a multi-access method. For example, if SC-FDMA is used as an uplink multi-access method, the OFDM symbol may be called an SC-FDMA symbol. A Resource Block (RB) is a resource assignment unit, and it includes a plurality of continuous subcarriers in a single slot. The structure of the radio frame is only an example. Accordingly, the number of subframes included in the radio frame, the number of slots included in a subframe, or the number of OFDM symbols included in a slot may be changed in various ways.

In 3GPP LTE, a single slot is defined to include 7 OFDM symbols in a normal Cyclic Prefix (CP), and a single slot is defined to include 6 OFDM symbols in an extended CP.

A wireless communication system may be basically divided into a Frequency Division Duplex (TDD) method and a Time Division Duplex (TDD) method. In accordance with the FDD method, uplink transmission and downlink transmission are performed while occupying different frequency bands. In accordance with the TDD method, uplink transmission and downlink transmission are performed at different points of time while occupying the same frequency band. A channel response in the TDD method is substantially reciprocal. This means that in a given frequency domain, a downlink channel response and an uplink channel response are almost the same. Accordingly, in a wireless communication system based on TDD, there is an advantage in that a downlink channel response may be obtained from an uplink channel response. In the TDD method, downlink transmission by a BS and uplink transmission by UE may not be performed at the same time because the uplink transmission and the downlink transmission are time-divided in the entire frequency band. In a TDD system in which uplink transmission and downlink transmission are divided in a subframe unit, the uplink transmission and the downlink transmission are performed in different subframes.

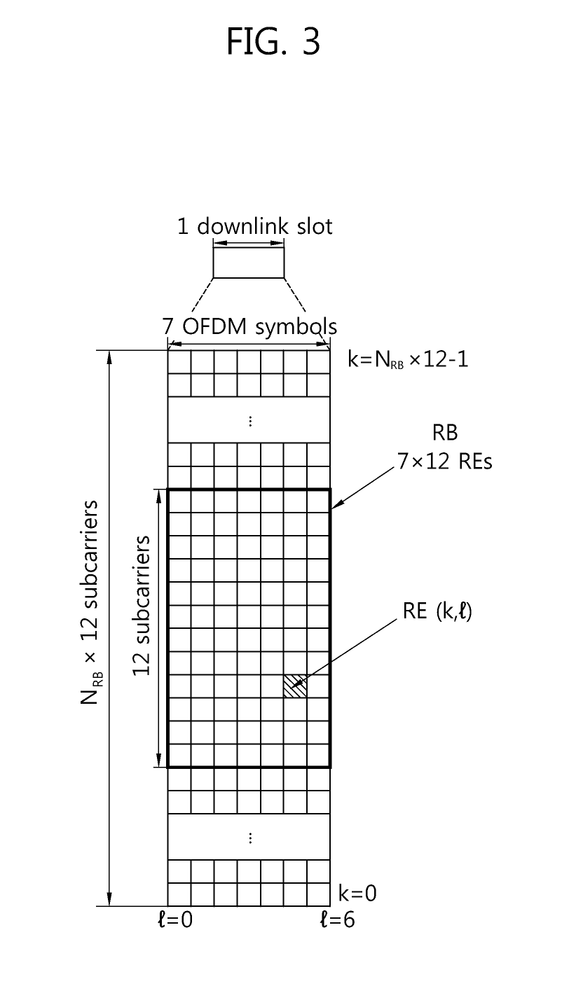

FIG. 3 shows an example of a resource grid for a single downlink slot.

The downlink slot includes a plurality of OFDM symbols in the time domain and includes an N_{RB} number of Resource Blocks (RBs) in the frequency domain. The number of resource blocks N_{RB} included in a downlink slot depends on a downlink transmission bandwidth configured in a cell. For example, in an LTE system, the number of resource blocks N_{RB} may be any one of 6 to 110. A single resource block includes a plurality of subcarriers in the frequency domain. The structure of an uplink slot may be the same as that of the downlink slot.

Each of elements on a resource grid is referred to as a Resource Element (RE). The resource element on the resource grid may be identified by an index pair (k,l) within a slot. In such a case, k (k=0, . . . , N_{RB}x12-1) is a subcarrier index in the frequency domain, and l (l=0, . . . , 6) is an OFDM symbol index in the time domain.

In this case, a single resource block is illustrated as including 7×12 resource elements, including 7 OFDM symbols in the time domain and 12 subcarriers in the frequency domain, but the number of OFDM symbols and the number of subcarriers within the resource block are not limited thereto. The number of OFDM symbols and the number of subcarriers may be changed in various manners depending on the length of a CP, frequency spacing, etc. For example, in the case of a normal CP, the number of OFDM symbols is 7, and in the case of an extended CP, the number of OFDM symbols is 6. In a single OFDM symbol, a single of 128, 256, 512, 1024, 1536, and 2048 may be selected and used as the number of subcarriers.

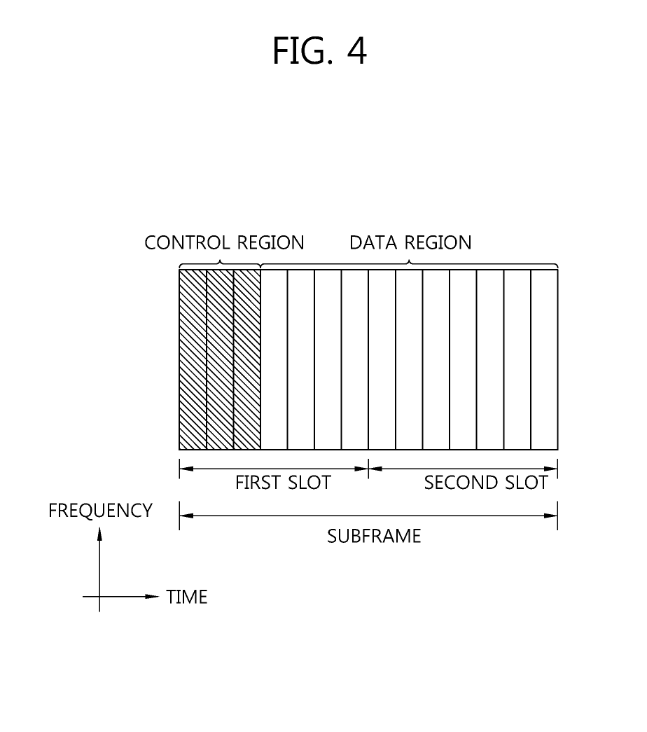

FIG. 4 shows the structure of a DL subframe.

The DL subframe includes two slots in a time domain, and each of the slots includes 7 OFDM symbols in a normal CP. A maximum of the former 3 OFDM symbols (a maximum of 4 OFDM symbols in a 1.4 MHz bandwidth) in the first slot of the DL subframe become a control region to which control channels are assigned, and the remaining OFDM symbols become a data region to which Physical Downlink Shared Channel (PDSCH) are assigned.

A PCFICH transmitted in the first OFDM symbol of a subframe carries a Control Format Indicator (CIF) regarding the size of OFDM symbols (i.e., the size of a control region) that are used for the transmission of control channels within the subframe. UE first receives a CFI on the PCFICH and then monitors a PDCCH. Unlike the PDCCH, the PCFICH is transmitted through the fixed PCFICH resources of the subframe without using blind decoding.

A PHICH carries a positive-acknowledgement (ACK)/negative-acknowledgement (NACK) signal for an UL Hybrid Automatic Repeat Request (HARQ). An ACK/NACK signal for UL data on a PUSCH that is transmitted by UE is transmitted on a PHICH.

A physical broadcast channel (PBCH) is transmitted in the former 4 OFDM symbols of the second slot in the first subframe of a radio frame. The PBCH carries system information that is essential for UE to communicate with a BS, and system information transmitted through a PBCH is called a Master Information Block (MIB). In contrast, system information transmitted on a PDSCH indicated by a PDCCH is called a System Information Block (SIB).

Control information transmitted through a PDCCH is called DL Control Information (DCI). DCI may include the resource assignment of a PDSCH (this is also called a DL grant), the resource assignment of a PUSCH (this is also called an UL grant), a set of transmission power control instructions for individual UE within a specific UE group and/or the activation of a Voice over Internet Protocol (VoIP).

A PDCCH may carry information about the assignment of resources and about the transport format of a Downlink-Shared Channel (DL-SCH), information about the assignment of resources on an Uplink Shared Channel (UL-SCH), paging information on a PCH, system information on a DL-SCH, the resource assignment of a higher layer control message, such as a random access response transmitted on a PDSCH, a set of transmission power control commands for individual UE within a specific MS group, and the activation of a Voice over Internet Protocol (VoIP). A plurality of PDCCHs may be transmitted within the control region, and UE may monitor a plurality of PDCCHs. A PDCCH is transmitted on a single Control Channel Element (CCE) or an aggregation of some contiguous CCEs. A CCE is a logical assignment unit that is used to provide a PDCCH with a coding rate according to the state of a radio channel. A CCE corresponds to a plurality of Resource Element Groups (REGs). The format of a PDCCH and the possible number of bits of a PDCCH are determined by a relationship between the number of CCEs and a coding rate provided by the CCEs.

A BS determines a PDCCH format based on a DCI to be transmitted to UE and attaches Cyclic Redundancy Check (CRS) to control information. A unique identifier (a Radio Network Temporary Identifier (RNTI)) is masked to the CRC depending on the owner or use of a PDCCH. If the PDCCH is a PDCCH for specific UE, an identifier unique to the UE, for example, a Cell-RNTI (C-RNTI) may be masked to the CRC. If the PDCCH is a PDCCH for a paging message, a paging indication identifier, for example, a Paging-RNTI (P-RNTI) may be masked to the CRC. If the PDCCH is a PDCCH for a System Information Block (SIB), a system information identifier, for example, a System Information-RNTI (SI-RNTI) may be masked to the CRC. A Random Access-RNTI (RA-RNTI) may be masked to the CRC in order to indicate a random access response, that is, a response to the transmission of a random access preamble by UE.

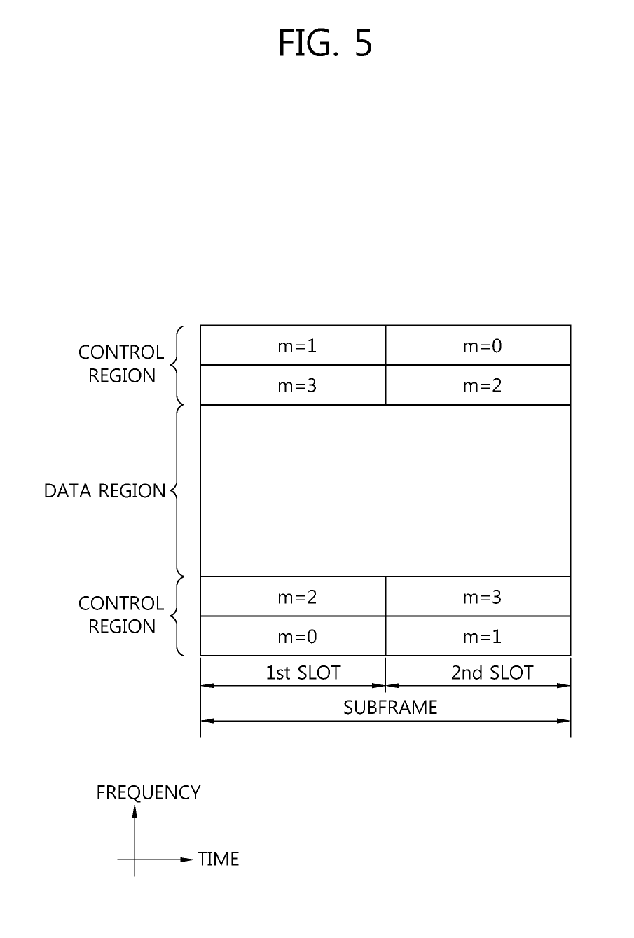

FIG. 5 shows the structure of an UL subframe.

The UL subframe may be divided into a control region and a data region in a frequency domain. A physical uplink control channel (PUCCH) on which uplink control information is transmitted is allocated to the control region. A physical uplink shared channel (PUSCH) on which data is transmitted is allocated to the data region. If indication is made by an upper layer, UE may support the simultaneous transmission of a PUSCH and a PUCCH.

A PUCCH for a single MS is assigned as an RB pair in a subframe. Resource blocks belonging to the RB pair occupy different subcarriers in a first slot and a second slot. A frequency occupied by a resource block that belongs to the RB pair assigned to the PUCCH is changed based on a slot boundary. This is said that the RB pair assigned to the PUCCH has been subject to frequency-hopping at the slot boundary. The MS may obtain a frequency diversity gain by sending uplink control information through different subcarriers over time. m is a location index indicative of the location of a logical frequency domain of the RB pair assigned to the PUCCH in the subframe.

UL control information transmitted on a PUCCH includes Hybrid Automatic Repeat Request (HARQ) acknowledgement (ACK), a Channel Quality Indicator (CQI) indicative of a downlink channel state, and a Scheduling Request (SR), that is, an uplink radio resource assignment request.

A PUSCH is mapped to an UL-SCH that is a transport channel. Uplink data transmitted on the PUSCH may be a transport block, that is, a data block for the UL-SCH transmitted during a TTI. The transport block may be user information, or the uplink data may be multiplexed data. The multiplexed data may be obtained by multiplexing the transport block for the UL-SCH and control information. For example, control information multiplexed with data may include a CQI, a Precoding Matrix Indicator (PMI), HARQ, and a Rank Indicator (RI). Alternatively, the uplink data may include only the control information.

In order to improve the performance of a wireless communication system, technology evolves toward the direction in which the density of nodes accessible to users nearby is increased. The performance of a wireless communication system having a high density of nodes can be further improved through cooperation between the nodes.

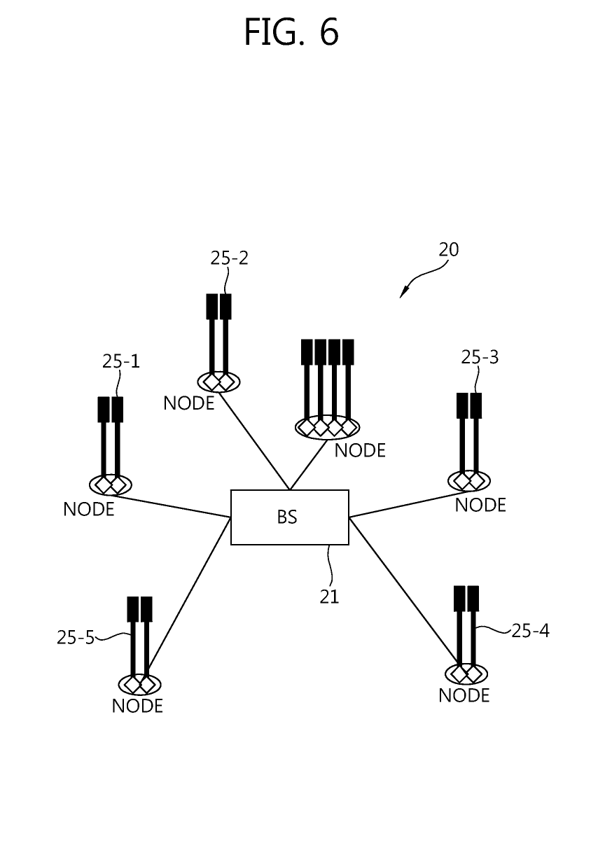

FIG. 6 shows an example of a multi-node system.

Referring to FIG. 6, a multi-node system 20 may consist of a single BS 21 and a plurality of nodes 25-1, 25-2, 25-3, 25-4, and 25-5. The plurality of nodes 25-1, 25-2, 25-3, 25-4, and 25-5 may be managed by the single BS 21. That is, the plurality of nodes 25-1, 25-2, 25-3, 25-4, and 25-5 operates like part of a single cell. In this case, each of the nodes 25-1, 25-2, 25-3, 25-4, and 25-5 may be assigned a separate node identifier (ID), or may operate like some antenna group within a cell without a separate node ID. In such a case, the multi-node system 20 of FIG. 6 may be considered to be a Distributed Multi-Node System (DMNS) that form a single cell.

Alternatively, the plurality of nodes 25-1, 25-2, 25-3, 25-4, and 25-5 may have respective cell IDs, and may perform the scheduling and handover (HO) of UE. In such a case, the multi-node system 20 of FIG. 6 may be considered to be a multi-cell system. The BS 21 may be a macro cell, and each of the nodes may be a femto cell or pico cell that has smaller cell coverage than the macro cell. If, as described above, a plurality of cells is overlaid and configured according to coverage, this may be called a multi-tier network.

In FIG. 6, each of the nodes 25-1, 25-2, 25-3, 25-4, and 25-5 may be any one of a BS, a Node-B, an eNode-B, a pico cell eNb (PeNB), a home eNB (HeNB), a Radio Remote Head (RRH), a Relay Station (RS) or a repeater, and a distributed antenna. At least one antenna may be installed in a single node. Furthermore, the node may also be called a point. In the following specification, a node means an antenna group that is spaced apart from a multi-node system at a specific interval or higher. That is, in the following specification, each node is assumed to be an RRH physically. However, the present invention is not limited thereto, and a node may be defined as a specific antenna group regardless of a physical interval. For example, assuming that a BS consisting of a plurality of cross-polarized antennas includes nodes formed of horizontal-polarized antennas and nodes formed of vertical-polarized antennas, the present invention may be applied. Furthermore, the present invention may also be applied even in the case where each node is a pico cell or a femto cell having smaller cell coverage than a macro cell, that is, in a multi-cell system. In the following description, an antenna may be replaced with an antenna port, a virtual antenna, or an antenna group in addition to a physical antenna.

A Reference Signal (RS) is described.

An RS is commonly transmitted in the form of a, sequence. A specific sequence may be used as an RS sequence without special limits. A Phase Shift Keying (PSK)-based computer generated sequence based on PSK may be used as the RS sequence. PSK may include, for example, Binary Phase Shift Keying (BPSK) and Quadrature Phase Shift Keying (QPSK). Alternatively, a Constant Amplitude Zero Auto-Correlation (CAZAC) sequence may be used as the RS sequence. The CAZAC sequence may include, for example, a Zadoff-Chu (ZC)-based sequence, a ZC sequence with cyclic extension, and a ZC sequence with truncation. Alternatively, a pseudo-random (PN) sequence may be used as the RS sequence. The PN sequence may include, for example, an m-sequence, a computer-generated sequence, a gold sequence, and a Kasami sequence. Alternatively, a cyclically shifted sequence may be used as the RS sequence.

A DL RS may be classified into a Cell-specific Reference Signal (CRS), a Multimedia Broadcast and multicast Single Frequency Network (MBSFN) RS, a UE-specific RS, a Positioning RS (PRS), and a Channel State Information-RS (CSI-RS). The CRS is an RS transmitted to all pieces of UE within a cell, and the CRS may be used for the channel measurement of Channel Quality Indicator (CQI) feedback and the channel estimation of a PDSCH. The MBSFN RS may be transmitted in a subframe assigned for the transmission of an MBSFN. The UE-specific RS is an RS received by specific UE or a specific UE group within a cell, and may be called a demodulation RS (DMRS). The DMRS may be used for specific UE or a specific UE group to perform data demodulation. The PRS may be used to estimate the location of UE. The CSI-RS is used for the channel estimation of the PDSCH of LTE-A UE. The CSI-RS is relatively sparsely disposed in a frequency domain or a time domain, and may be punctured in the data region of a common subframe or MBSFN subframe. A CQI, a PMI, an RI, etc. may be reported by UE through the estimation of a CSI, if necessary.

The CRS is transmitted in all DL subframes within a cell which supports PDSCH transmission. The CRS may be transmitted on antenna ports 0 to 3, and the CRS may be defined for only Δf=15 kHz. For the CRS, reference may be made to Paragraph 6.10.1 of 3^{rd} Generation Partnership Project (3GPP) TS 36.211 V10.1.0 (2011 March) “Technical Specification Group Radio Access Network; Evolved Universal Terrestrial Radio Access (E-UTRA); Physical channels and modulation (Release 8)”.

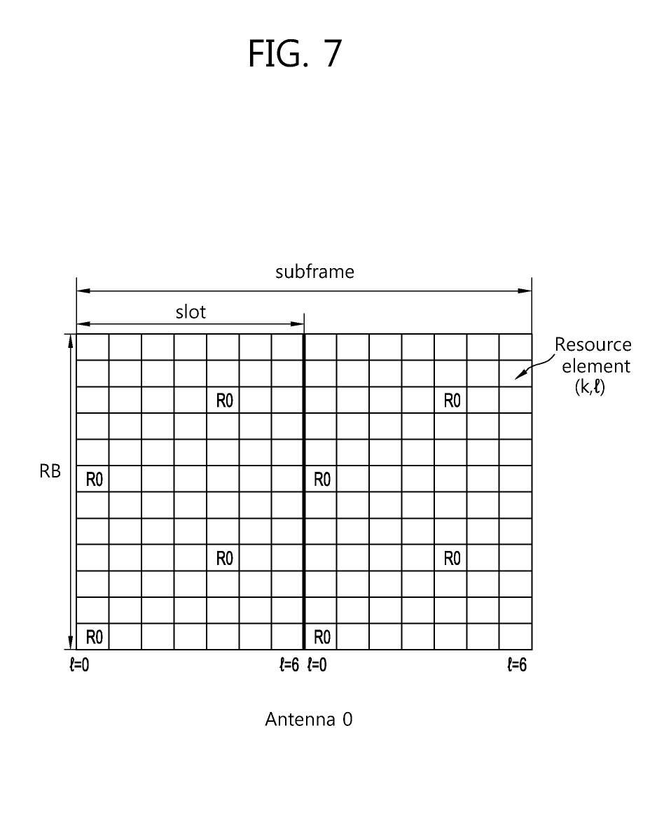

FIGS. 7 to 9 show examples of an RB to which a CRS is mapped.

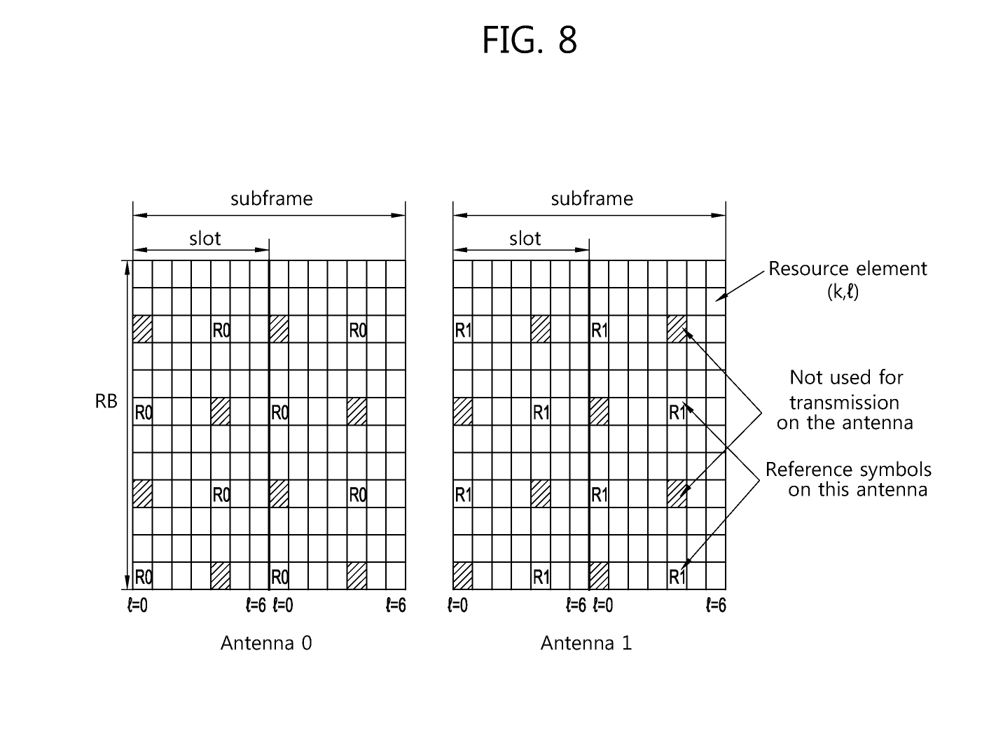

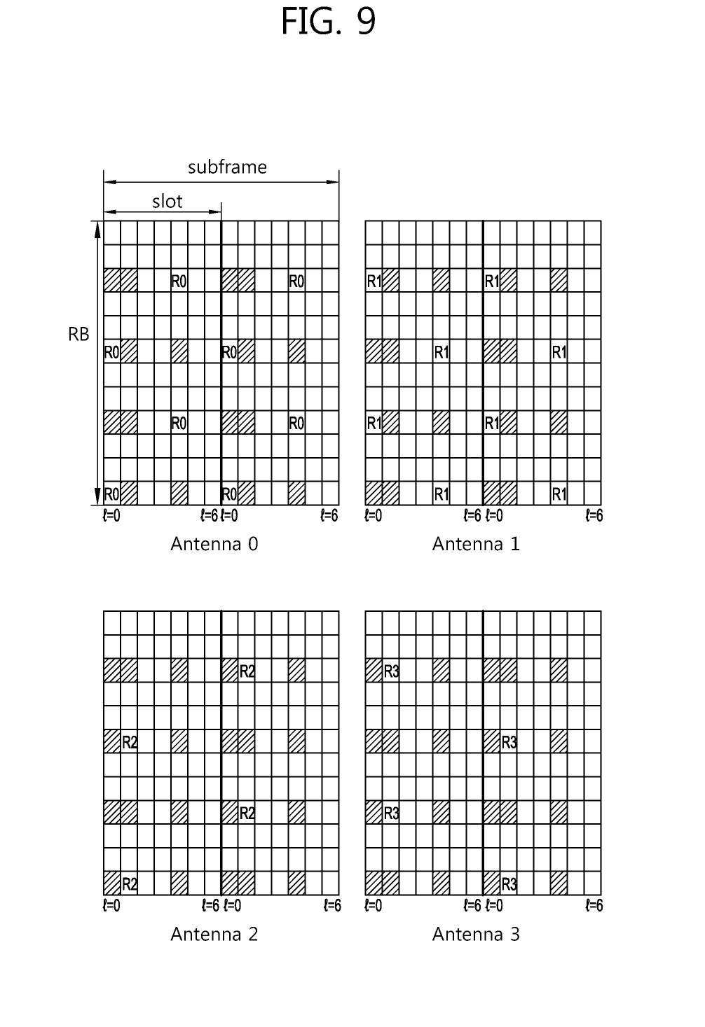

FIG. 7 shows an example of a pattern in which a CRS is mapped to RB if a BS uses a single antenna port, FIG. 8 shows an example of a pattern in which a CRS is mapped to RB if a BS uses two antenna ports, and FIG. 9 shows an example of a pattern in which a CRS is mapped to RB if a BS uses four antenna ports. Furthermore, the CRS pattern may be used to support the characteristics of LTE-A. For example, the CRS pattern may be used to support the characteristics of a Coordinated Multi-Point (CoMP) transmission reception scheme or spatial multiplexing. Furthermore, the CRS may be used for channel quality measurement, the detection of a CP, and time/frequency synchronization.

Referring to FIGS. 7 to 9, in the case of multiple antenna transmission when a BS uses a plurality of antenna ports, a single resource grid is present in each antenna port. ‘R0’ indicates an RS for a first antenna port, ‘R1’ indicates an RS for a second antenna port, ‘R2’ indicates an RS for a third antenna port, and ‘R3’ indicates an RS for a fourth antenna port. Locations the subframes of R0 to R3 are not overlapped with each other. l is the location of an OFDM symbol within a slot, and it has a value between 0 and 6 in a normal CP. In a single OFDM symbol, an RS for each antenna port is placed at 6-subcarrier intervals. The number or R0 and the number of R1 within a subframe are the same, and the number of R2 and the number of R3 are the same. The number of R2 and R3 within a subframe is smaller than the number of R0 and R1. A resource element used in the RS of one antenna port is not used in the RS of other antennas. This reason for this is that antenna ports do not interfere with each other.

A CRS is transmitted always by the number of antenna ports regardless of the number of streams. The CRS has an independent RS in each antenna port. The location of a CRS in a frequency domain and the location of a CRS in a time domain within a subframe are determined regardless of UE. A CRS sequence by which a CRS is multiplied is also generated regardless of UE. Accordingly, all pieces of UE within a cell may receive a CRS. However, the location of a CRS within a subframe and a CRS sequence may be determined by a cell ID. The location of a CRS in a time domain within a subframe may be determined by an antenna port number and the number of OFDM symbols within an RB. The location of a CRS in a frequency domain within a subframe may be determined by an antenna number, a, cell ID, an OFDM symbol index t, and a slot number within a radio frame.

A two-dimension CRS sequence may be generated by the product of the symbols of a two-dimensional orthogonal sequence and a two-dimensional pseudo-random sequence. 3 different two-dimensional orthogonal sequences and 170 different two-dimensional pseudo-random sequences may be present. Each cell ID corresponds to a unique combination of a single orthogonal sequence and a single pseudo-random sequence. Furthermore, frequency hopping may be applied to a CRS. A frequency hopping pattern may have a single radio frame 10 ms, and each frequency hopping pattern corresponds to a single cell ID group.

A CSI-RS is transmitted through 1, 2, 4, or 8 antenna ports. In this case, the antenna port used are p=15, p=15, 16, p=15, . . . , 18 and p=15, . . . , 22, respectively. A CSI-RS may be defined for only Δf=15 kHz. For a CSI-RS, reference may be made to Paragraph 6.10.5 of 3GPP TS 36.211 V10.1.0 (2011 March) “Technical Specification Group Radio Access Network; Evolved Universal Terrestrial Radio Access (E-UTRA); Physical channels and modulation (Release 8)”.

In the transmission of a CSI-RS, in a multi-cell environment including a heterogeneous network (HetNet) environment, a maximum of 32 different configurations may be proposed in order to reduce Inter-Cell Interference (ICI). The CSI-RS configuration is different depending on the number of antenna ports within a cell and a CP, and neighboring cells may have different configurations to the highest degree. Furthermore, the CSI-RS configuration may be divided into a case where it is applied to both an FDD frame and a TDD frame and a case where it is applied to only a TDD frame depending on a frame structure. In a single cell, a plurality of CSI-RS configurations may be used. 0 or 1 CSI-RS configuration may be used in UE that assumes a non-zero power CSI-RS, and 0 or multiple CSI-RS configurations may be used in UE that assumes a zero-power CSI-RS.

The CSI-RS configuration may be indicated by a higher layer. A CSI-RS-Config Information Element (IE) transmitted through a higher layer may indicate a CSI-RS configuration. The CSI-RS-Config IE may be a UE-specific message. That is, a different CSI-RS-Config IE may be transmitted for each UE. Table 1 shows an example of the CSI-RS-Config IE.

TABLE 1
-- ASN1START

| | |
|---|---|
| CSI-RS-Config-r10 ::= | SEQUENCE { |

| | |
|---|---|
| csi-RS-r10 | CHOICE { |

| | |
|---|---|
| release | NULL, |
| setup | SEQUENCE { |

| | |
|---|---|
| antennaPortsCount-r10 | ENUMERATED {an1, an2, an4, |

an8},

| | |
|---|---|
| resourceConfig-r10 | INTEGER (0..31), |
| subframeConfig-r10 | INTEGER (0..154), |

| | |
|---|---|
| p-C-r10 | INTEGER (−8..15) |

}

| | | |
|---|---|---|
| } | OPTIONAL, | -- Need ON |

| | |
|---|---|
| zeroTxPowerCSI-RS-r10 | CHOICE { |

| | |
|---|---|
| release | NULL, |
| setup | SEQUENCE { |

| | |
|---|---|
| zeroTxPowerResourceConfigList-r10 | BIT STRING (SIZE (16)), |

| | |
|---|---|
| zeroTxPowerSubframeConfig-r10 | INTEGER (0..154) |

}

| | | |
|---|---|---|
| } | OPTIONAL | -- Need ON |

}
-- ASN1STOP

Referring to Table 1, the antennaPortsCount field indicates the number of antenna ports used for the transmission of a CSI-RS. The resourceConfig field indicates a CSI-RS configuration. The SubframeConfig field and the zeroTxPowerSubframeConfig field indicate a subframe configuration transmitted by the CSI-RS.

The zeroTxPowerResourceConfigList field indicates a zero-power CSI-RS configuration. In a 16-bit bitmap that forms the zeroTxPowerResourceConfigList field, a CSI-RS configuration corresponding to a bit set to 1 may be configured as a zero-power CSI-RS. More specifically, the Most Significant Bit (MSB) of the bitmap that forms the zeroTxPowerResourceConfigList field corresponds to the first CSI-RS configuration index if the number of CSI-RSs is four in Tables 2 and 3. Subsequent bits in the bitmap that forms the zeroTxPowerResourceConfigList field correspond in the direction in which a CSI-RS configuration index is increased if the number of CSI-RSs is 4 in Tables 2 and 3. Table 2 shows the configuration of a CSI-RS in a normal CP, and Table 3 shows the configuration of a CSI-RS in an extended CP.

TABLE 2

| | | Number of configured CSI-RSs | | | | | |
|---|---|---|---|---|---|---|---|
| | | 1 or 2 | | 4 | | 8 | |
| | | | nₛ | | nₛ | | nₛ |
| | CSI RS | | mod | | mod | | mod |
| | configuration | (k′, l′) | 2 | (k′, l′) | 2 | (k′, l′) | 2 |
| TDD | 0 | (9, 5) | 0 | (9, 5) | 0 | (9, 5) | 0 |
| and | 1 | (11, 2) | 1 | (11, 2) | 1 | (11, 2) | 1 |
| FDD | 2 | (9, 2) | 1 | (9, 2) | 1 | (9, 2) | 1 |
| frame | 3 | (7, 2) | 1 | (7, 2) | 1 | (7, 2) | 1 |
| | 4 | (9, 5) | 1 | (9, 5) | 1 | (9, 5) | 1 |
| | 5 | (8, 5) | 0 | (8, 5) | 0 | | |
| | 6 | (10, 2) | 1 | (10, 2) | 1 | | |
| | 7 | (8, 2) | 1 | (8, 2) | 1 | | |
| | 8 | (6, 2) | 1 | (6, 2) | 1 | | |
| | 9 | (8, 5) | 1 | (8, 5) | 1 | | |
| | 10 | (3, 5) | 0 | | | | |
| | 11 | (2, 5) | 0 | | | | |
| | 12 | (5, 2) | 1 | | | | |
| | 13 | (4, 2) | 1 | | | | |
| | 14 | (3, 2) | 1 | | | | |
| | 15 | (2, 2) | 1 | | | | |
| | 16 | (1, 2) | 1 | | | | |
| | 17 | (0, 2) | 1 | | | | |
| | 18 | (3, 5) | 1 | | | | |
| | 19 | (2, 5) | | | | | |
| TDD | 20 | (11, 1) | 1 | (11, 1) | 1 | (11, 1) | 1 |
| frame | 21 | (9, 1) | 1 | (9, 1) | 1 | (9, 1) | 1 |
| | 22 | (7, 1) | 1 | (7, 1) | 1 | (7, 1) | 1 |
| | 23 | (10, 1) | 1 | (10, 1) | 1 | | |
| | 24 | (8, 1) | 1 | (8, 1) | 1 | | |
| | 25 | (6, 1) | 1 | (6, 1) | 1 | | |
| | 26 | (5, 1) | 1 | | | | |
| | 27 | (4, 1) | 1 | | | | |
| | 28 | (3, 1) | 1 | | | | |
| | 29 | (2, 1) | 1 | | | | |
| | 30 | (1, 1) | 1 | | | | |
| | 31 | (0, 1) | 1 | | | | |

TABLE 3

| | | Number of configured CSI-RSs | | | | | |
|---|---|---|---|---|---|---|---|
| | | 1 or 2 | | 4 | | 8 | |
| | | | nₛ | | nₛ | | nₛ |
| | CSI RS | | mod | | mod | | mod |
| | configuration | (k′, l′) | 2 | (k′, l′) | 2 | (k′, l′) | 2 |
| TDD | 0 | (11, 4) | 0 | (11, 4) | 0 | (11, 4) | 0 |
| and | 1 | (9, 4) | 0 | (9, 4) | 0 | (9, 4) | 0 |
| FDD | 2 | (10, 4) | 1 | (10, 4) | 1 | (10, 4) | 1 |
| frame | 3 | (9, 4) | 1 | (9, 4) | 1 | (9, 4) | 1 |
| | 4 | (5, 4) | 0 | (5, 4) | 0 | | |
| | 5 | (3, 4) | 0 | (3, 4) | 0 | | |
| | 6 | (4, 4) | 1 | (4, 4) | 1 | | |
| | 7 | (3, 4) | 1 | (3, 4) | 1 | | |
| | 8 | (8, 4) | 0 | | | | |
| | 9 | (6, 4) | 0 | | | | |
| | 10 | (2, 4) | 0 | | | | |
| | 11 | (0, 4) | 0 | | | | |
| | 12 | (7, 4) | 1 | | | | |
| | 13 | (6, 4) | 1 | | | | |
| | 14 | (1, 4) | 1 | | | | |
| | 15 | (0, 4) | 1 | | | | |
| TDD | 16 | (11, 1) | 1 | (11, 1) | 1 | (11, 1) | 1 |
| frame | 17 | (10, 1) | 1 | (10, 1) | 1 | (10, 1) | 1 |
| | 18 | (9, 1) | 1 | (9, 1) | 1 | (9, 1) | 1 |
| | 19 | (5, 1) | 1 | (5, 1) | 1 | | |
| | 20 | (4, 1) | 1 | (4, 1) | 1 | | |
| | 21 | (3, 1) | 1 | (3, 1) | 1 | | |
| | 22 | (8, 1) | 1 | | | | |
| | 23 | (7, 1) | 1 | | | | |
| | 24 | (6, 1) | 1 | | | | |
| | 25 | (2, 1) | 1 | | | | |
| | 26 | (1, 1) | 1 | | | | |
| | 27 | (0, 1) | 1 | | | | |

Referring to Table 2, the bits of the bitmap that forms the zeroTxPowerResourceConfigList field correspond to the respective CSI-RS configuration indices 0, 1, 2, 3, 4, 5, 6, 7, 8, 9, 20, 21, 22, 23, 24, and 25 from the MSB (most significant bit). Referring to Table 3, the bits of the bitmap that forms the zeroTxPowerResourceConfigList field correspond to the respective CSI-RS configuration indices 0, 1, 2, 3, 4, 5, 6, 7, 16, 17, 18, 19, 20 and 21 from the MSB. UE may assume resource elements, corresponding to the CSI-RS configuration indices set as a zero-power CSI-RS, as resource elements for the zero-power CSI-RS. However, resource elements set as resource elements for a non-zero power CSI-RS by a higher layer may be excluded from the resource elements for the zero-power CSI-RS.

The UE may send a CSI-RS only in a downlink slot that satisfies the condition of nₛ mod 2 in Tables 2 and 3. Furthermore, the UE does not send a CSI-RS in a special subframe of a TDD frame, a subframe in which the transmission of the CSI-RS collides against a synchronization signal, a physical broadcast channel (PBCH), an SIB type 1 ‘SystemInformationBlockType1’, or a subframe in which a paging message is transmitted. Furthermore, in a set S, that is, S={15}, S={15, 16}, S={17, 18}, S={19, 20}, or S={21, 22}, resource elements in which the CSI-RS of a single antenna port is transmitted are not used in the transmission of a PDSCH or the CSI-RS of another antenna port.

Table 4 shows an example of subframe configurations in which a CSI-RS is transmitted.

TABLE 4

| CSI-RS-SubframeConfig | CSI-RS periodicity | CSI-RS subframe offset |
|---|---|---|
| I_{CSI-RS} | T_{CSI-RS} (subframes) | Δ_{CSI-RS} (subframes) |
| 0-4 | 5 | I_{CSI-RS} |
| 5-14 | 10 | I_{CSI-RS} − 5 |
| 15-34 | 20 | I_{CSI-RS} − 15 |
| 35-74 | 40 | I_{CSI-RS} − 35 |
| 75-154 | 80 | I_{CSI-RS} − 75 |

Referring to Table 4, the periodicity T_{CSI-RS} and offset Δ_{CSI-RS} of a subframe in which a CSI-RS is transmitted may be determined depending on a CSI-RS subframe configuration I_{CSI-RS}. The CSI-RS subframe configuration of Table 4 may be any one of the SubframeConfig field and the ZeroTxPowerSubframeConfig field in the CSI-RS-Config IE of Table 1. The CSI-RS subframe configuration may be separated from a non-zero power CSI-RS and a zero-power CSI-R, and may be separately configured. Meanwhile, a subframe in which a CSI-RS is transmitted needs to satisfy Equation 1.

(10n_{f}+└nₛ/2┘−Δ_{CSI-RS})mod T_{CSI-RS}=0 <Equation 1>

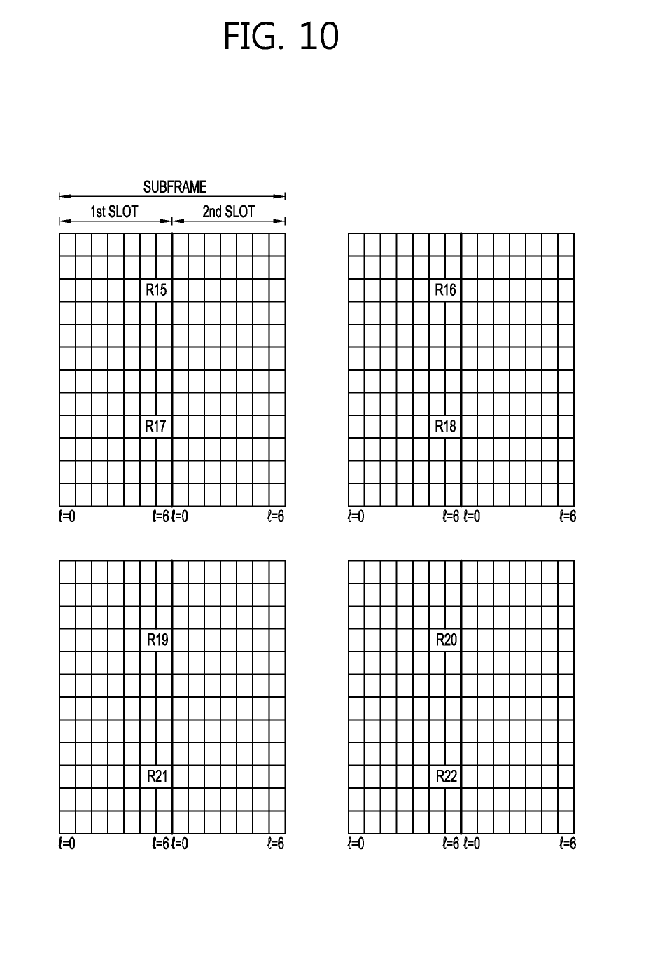

FIG. 10 shows an example of an RB to which a CSI-RS is mapped.

FIG. 10 shows resource elements used for a CSI-RS when a CSI-RS configuration index is 0 in a normal CP structure. Rp indicates a resource element used in the transmission of a CSI-RS on an antenna port p. Referring to FIG. 10, a CSI-RS for an antenna port 15, 16 is transmitted through a resource element corresponding to the third subcarrier (a subcarrier index 2) of the sixth and the seventh OFDM symbols (OFDM symbol indices 5 and 6) of a first slot. A CSI-RS for an antenna port 17, 18 is transmitted through a resource element corresponding to the ninth subcarrier (a subcarrier index 8) of sixth and seventh OFDM symbols (OFDM symbol indices 5 and 6) of the first slot. A CSI-RS for an antenna port 19, 20 is transmitted through a resource element corresponding to the fourth subcarrier (a subcarrier index 3) of the sixth and the seventh OFDM symbols (OFDM symbol indices 5 and 6) of the first slot. A CSI-RS for an antenna port 21, 22 is transmitted through a resource element corresponding to the tenth subcarrier (a subcarrier index 9) of the sixth and the seventh OFDM symbols (OFDM symbol indices 5 and 6) of the first slot.

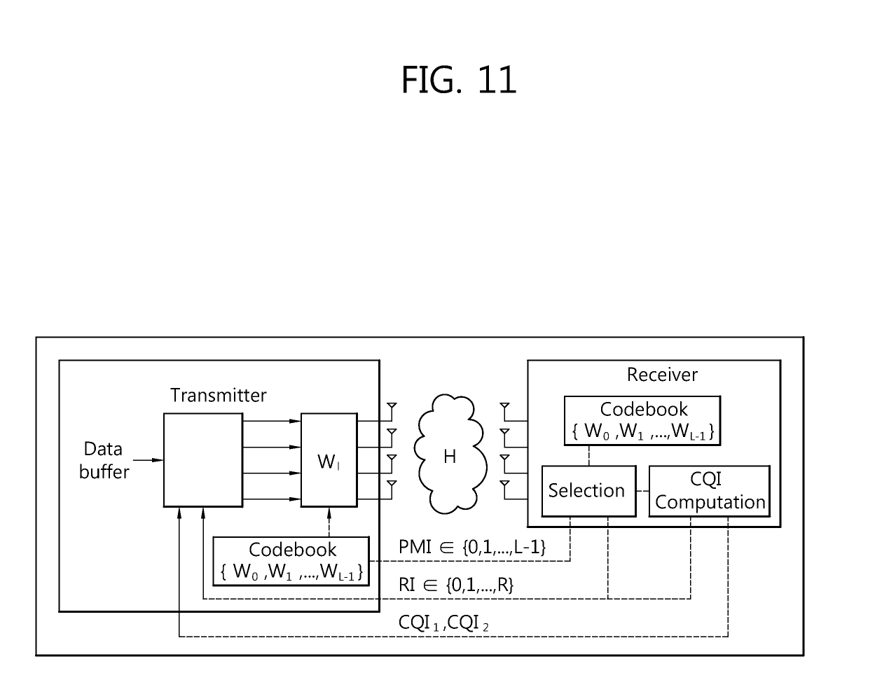

FIG. 11 shows the concept of CSI feedback.

Referring to FIG. 11, when a transmitter sends an RS, for example, a CSI-RS, a receiver measures a CSI-RS, generates CSI, and feeds the CSI-RS back to the transmitter. The CSI includes a Precoding Matrix Index (PMI), rank indication (RI), a Channel Quality Indicator (CQI), etc.

An RI is determined by the number of assigned transport layers and obtained from related DCI. The PMI is applied to closed loop multiplexing and a large delay CDD. The receiver calculates the post-processing SINR of each PMI in relation to each of rank values 1 to 4, converts the calculated SINR into a sum capacity, and selects an optimum PMI from a codebook based on the sum capacity. Furthermore, the receiver determines an optimum RI based on the sum capacity. The CQI indicates channel quality, and a 4-bit index may be given as in the following table. UE may feed the indices of the following table back.

TABLE 5
CQI Table

| CQI index | modulation | coding rate x 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

The present invention is described below.

In general, in CSI measurement, in particular, in CQI measurement, an accurate Modulation and Coding Scheme (MCS) level may be determined only when the amount of interference is accurately measured. In the LTE standard specification, how UE measures interference using what method has not been defined in detail. In general, however, interference power is measured in such a way as to measure a channel with a serving cell using a CRS and subtract the transmission power of the serving cell from the total reception power of the UE.

There is a strong possibility that such an interference measurement method based on a CRS may become inaccurate as new functions are added to LTE. For example, a CRS RE to which a CRS is assigned is present both in a PDCCH region and a PDSCH region. However, if an interference cell that gives interference is in an empty buffer situation or an ‘Almost Blank Subframe (ABS) is applied for an enhanced Inter-Cell Interference Cancelation (eICIC) operation, interference measurement may become inaccurate between the interference of a PDCCH region may differ from the interference of a PDSCH region.

Furthermore, in the case of a CRS, in order to avoid a collision between CRSs in which the CRSs are transmitted using the same resources as those of a neighboring cell, different frequency shift values may be set in a serving cell and a neighboring cell. However, since the number of frequency shift values is limited (e.g., 3), it is difficult to avoid a collision between CRS in a situation in which cells become gradually dense.

Furthermore, in a single cell multi-node system, there is a problem in that interference between different nodes and UE within a cell cannot be measured using a CRS. Since a CRS is generated based on a cell ID, a plurality of nodes within a cell may use the same CRS in a multi-node system. Accordingly, it is difficult to distinguish channels of the respective nodes and measure interference from a viewpoint of the UE.

In interference measurement based on a CRS, one of methods for solving a problem in that it is difficult to distinguish nodes is a method of designating an interference measurement resource region using a zero-power CSI-RS configuration.

Such a method is a method in which a BS designates specific REs for UE as interference measurement REs so that the UE measures interference in the corresponding REs. For example, it is assumed that three nodes, that is, nodes A, B, and C, are present in a multi-node system. A BS may perform control so that the node A does not send any signal (i.e., the node A is muted) in a specific RE in which the nodes B and C send data. In this case, the BS may perform the aforementioned control process by assigning a CSI-RS configuration in which transmission power is not 0 in the specific RE to the nodes B and C and assigning a zero-power CSI-RS configuration in which transmission power is 0 in the specific RE to the node A. In such a situation, the BS may allow UE that tries to receive data from the node A to measure interference in the specific RE. Accordingly, the UE may accurately measure interference from the nodes B and C.

If an interference measurement method based on the aforementioned zero-power CSI-RS is applied, when performing a zero-power CSI-RS configuration, it is necessary to inform the UE whether resources to which the corresponding zero-power CSI-RS is assigned are 1) for interference measurement or 2) for reducing interference with surrounding nodes. The reason for this is that the operation of the UE may differ depending on 1) or 2). Accordingly, a method of adding information indicative of the object or purpose of the zero-power CSI-RS to an existing zero-power CSI-RS configuration message or a method of modifying and supplementing an existing zero-power CSI-RS configuration message may be taken into consideration.

In such an approach method, for backward compatibility, the UE-specific characteristic of an existing CSI-RS configuration remains intact. If the UE-specific characteristic is used, a different interference measurement resource region may be configured based on a different serving node set according to UE.

In this case, the serving node set includes nodes excluded from interference measurement, assuming that the serving node set does not give interference to UE. For example, the serving node set may be the same as any one of a CoMP cooperation set, a CoMP measurement set, an RRM measurement set, and a CoMP transport point that are defined in LTE Cooperative Multi-Point (CoMP) transmission and reception.

However, if a different interference measurement resource region is configured in a different serving node set according to UE as described above, there may be a problem in that muting resource overhead for interference measurement may be significantly increased.

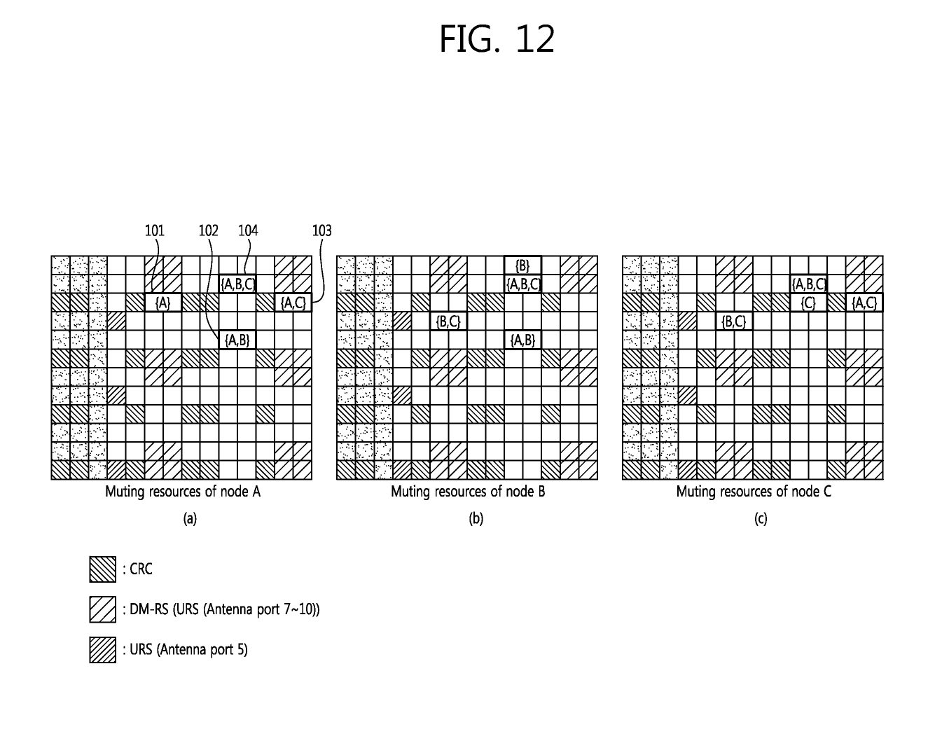

FIG. 12 shows an example in which muting resources for interference measurement are configured.

In FIG. 12, a resource region indicated by {X} is a region in which a zero-power CSI-RS is configured in a node X and the node X is muted. For example, {A} indicates a region in which a node A is muted, and {A,B} indicates a region in which nodes A and B are muted. UE using the node X as a serving node set measures interference in the resource region indicated by {X}.

For example, it is assumed that nodes A, B, and C are present and a plurality of pieces of UE is present in a multi-node system. The plurality of pieces of UE may receive UE that receives signals from only one of the nodes A, B, and C, UE that receives signals from two of the nodes A, B, and C, and UE that receives signals from all the nodes A, B, and C.

If the UE receivers data from only the node A, the UE needs to measure interference from the nodes B and C. In such a case, the UE measures interference from the nodes B and C in a resource region 101 indicated by {A} in FIG. 12(a). In the resource region 101, a zero-power CSI-RS is set in the node A, and thus the node A is muted.

Likewise, if the UE receives data from the nodes A and B, the UE needs to measures interference from the node C. In such a case, the UE measures interference from the node C in a resource region 102 indicated by {A,B} in FIG. 12(a). In the resource region 102, a zero-power CSI-RS is set in the nodes A and B, and thus the nodes A and B are muted.

A resource region 104 indicated by {A,B,C} may be a region for measuring the interference of other cells that neighbor a cell including the nodes A, B, and C. That is, in the resource region 104, a zero-power CSI-RS is set in all the nodes A, B, and C, and thus all the nodes A, B, and C are muted.

As shown in FIG. 12, each of the nodes A, B, and C needs to have four muting patterns (e.g., the regions 101, 102, 103, and 104 for the node A) in a single RB pair, and a total number of muting patterns that is assigned to the RB pair and distinguished from each other is 7.

If this is generally expanded, in a multi-node system including N nodes, a maximum of (2^{N}−1) muting patterns are required. Each of the N nodes may have to mute a maximum of 2^{(N-1)} patterns. A CSI-RS pattern that is 2TX transmission and in which a CSI-RS transmission periodicity T_{CSI-RS} is T ms (i.e., T subframes) requires muting resource overhead corresponding to 2 RE/(12·14·T)RE=0.0119/T in relation to a normal subframe. Accordingly, each node requires muting resource overhead corresponding to 2^{(N-1)}·0.0119/T. For example, if the number of nodes is N=6 and T=5 ms, muting resource overhead for a muting pattern is 2⁵·0.0119/5=7.62%. It can be seen that the resource overhead for the muting pattern is exponentially increased as an N value is increased.

If a different interference measurement resource region is configured based on a different serving node set according to UE as described above, there are problems in that muting resource overhead for interference measurement is greatly increased and system resource efficiency is deteriorated. The present invention proposes a method for solving such problems.

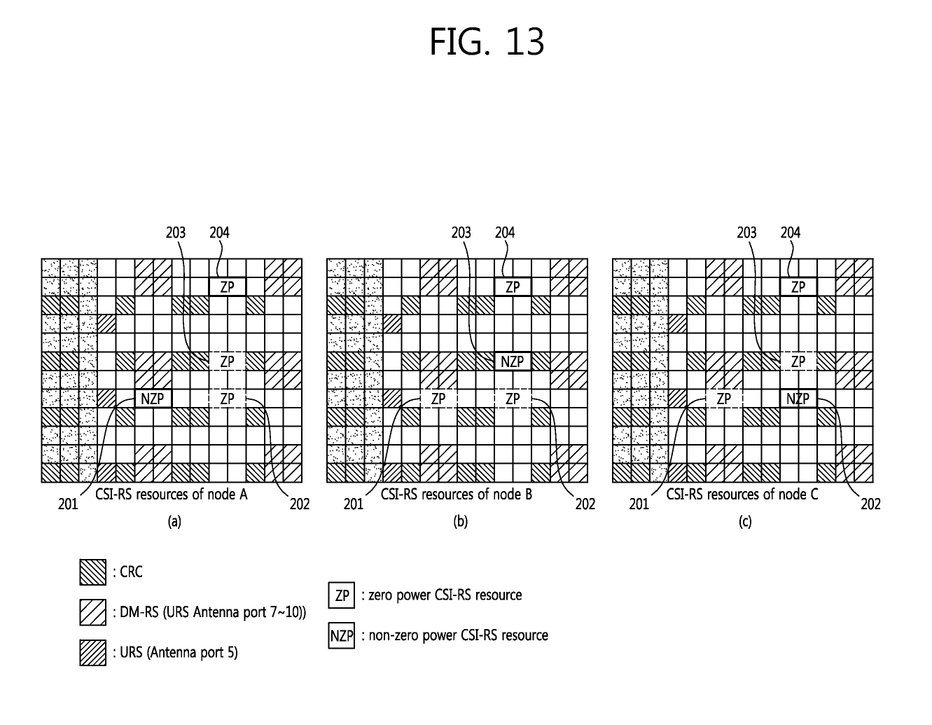

FIG. 13 shows the assignment of muting resources in accordance with an embodiment of the present invention.

It is assumed that three nodes (nodes A and B, and C) are present in a multi-node system. The nodes may have the same cell ID, or may have different cell IDs. A resource region 201 indicates an RE in which the node A sends a Non-Zero Power (NZP) CSI-RS, a resource region 203 indicates an RE in which the node B sends an NZP CSI-RS, and a resource region 202 indicates an RE in which the node C sends an NZP CSI-RS.

In such a case, a BS may configure an interference measurement region for a specific node set. That is, the BS may configure a resource region in which pieces of UE influenced by a node set may measure interference in such a manner that nodes belonging to the node set, including some of nodes within a cell, or the node set, including nodes belonging to different cells, perform muting. If such a resource region is called a node set-specific interference measurement region, UE may measure interference from the outside of the node set in a node set-specific interference measurement region. In FIG. 13, a resource region 204 shows an example of a proposed node set-specific interference measurement region. The node set-specific interference measurement region is called an NSIR, for convenience sake.

The NSIR may be the same resources muted by all N nodes if the N (N<M) nodes configures a cooperative node set in a cell including M nodes that use the same Physical Cell Identifier (PCI). Alternatively, if the N nodes using different PCIs configure a cooperative node set, the NSIR may be the same resources muted by all the N nodes. As a result, the NSIR may be called the same resources muted by all adjacent nodes that form a set regardless of whether or not the same PCI is used.

UE may measure interference from nodes outside a node set in the NSIR.

There is a disadvantage in that interference from nodes inside the node set cannot be measured because all the nodes within the node set are unable to perform muting in the NSIR. In order to solve such a problem, in the present invention, UE may correct the final amount of interference by estimating interference through a reference signal (e.g., CSI-RS) transmitted by a node within a node set.

That is, the UE may correct the amount of interference by estimating the channel or power of a node in a Resource Element (RE) in which each of nodes within a node set sends an NZP CSI-RS. That is, in FIG. 13, UE having the nodes A and B, and C as a node set and having {A,B} as serving nodes measures interference Iₒᵤₜ outside the node set in the NSIR 204. Furthermore, in order to estimate interference Iᵢₙ_{_{—}}_{C} from the node C, the UE measures a channel in the resource region 202 in which the node C sends an NZP CSI-RS. Thereafter, the UE may compute the final amount of interference by adding the interference Iₒᵤₜ outside the node set to the interference Iᵢₙ_{_{—}}_{C} from the node C, and may use the final amount of interference Iₜₒₜₐₗ to compute a CQI or feed the final amount of interference Iₜₒₜₐₗ back to a BS. That is, the UE may feed the final amount of interference Iₜₒₜₐₗ back to the BS, or may compute a CQI using the final amount of interference and feed the computed CQI back to the BS.

Other nodes (the nodes A and B in the example) may perform muting in the resource region in which the UE measures interference from a specific node within the node set (e.g., the resource region 202 in which the UE measures the interference Iᵢₙ_{_{—}}_{C} from the node C). That is, the nodes A and B may be configured to send a zero power CSI-RS in the resource region 202. In such a case, the channel estimation performance of pieces of UE that will receive data from the node C in the resource region 202 can be improved, and interference estimation in other pieces of UE that is subject to interference from the node C can be performed more precisely. However, the muting is not essential. That is, the UE may estimate the amount of interference (although it is a little inaccurate) although other nodes do not perform muting in an RE in which a target node sends an NZP CSI-RS because the UE is already aware of the RE, a reference signal sequence, etc. A resource region in which interference from an NZP CSI-RS is measured can be configured to the UE through a UE-specific CSI-RS configuration message.

In accordance with the present invention, if N nodes are present in a node set, a maximum of N muting resources may be given to each node. For example, if N=3, as shown in FIG. 13, muting resources are 204, that is, an NSIR, and 202 and 203 for reducing the NZP CSI-RS interference of an adjacent node in the node A. Muting resources are 204, and 201 and 202 in the node B, and muting resources are 204, and 201 and 203 in the node C.

In accordance with the present invention, in particular, if the number of nodes N is increased, a difference in muting resource overhead is further increased. That is, as described above, if an interference measurement region is configured in a UE-specific way, the overhead of muting resources requires a maximum of 2^{(N-1)} for each node. In contrast, muting resource overhead in the present invention is a maximum of N. Accordingly, if N is increased, muting resource overhead is reduced as compared with a UE-specific interference measurement region configuration.

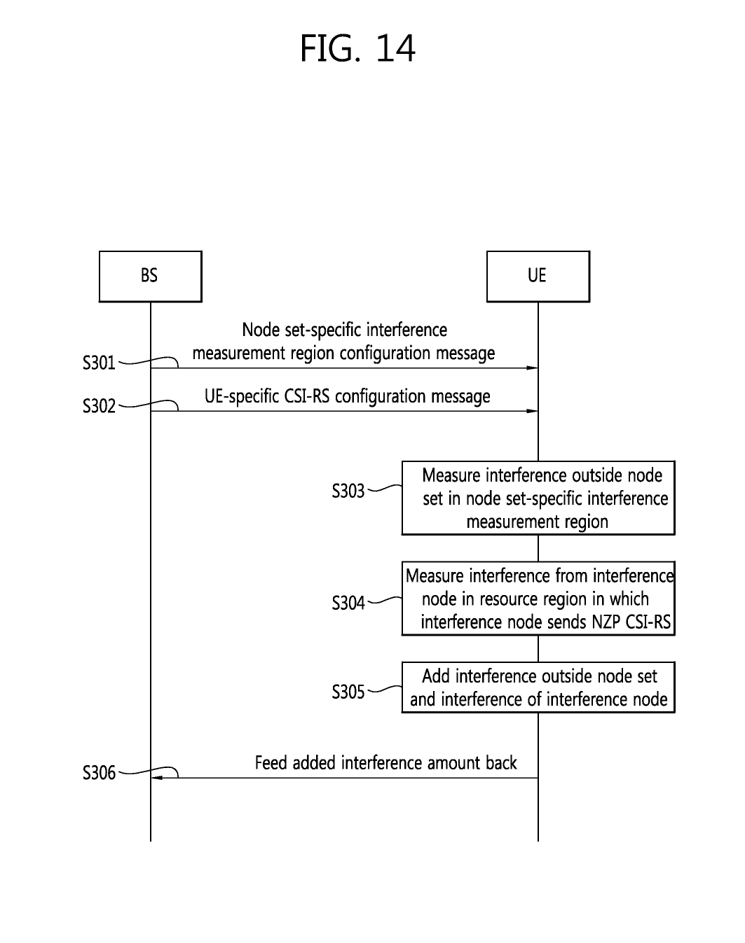

FIG. 14 shows an interference measurement method of UE in accordance with an embodiment of the present invention.

Referring to FIG. 14, the UE receives a Node set-Specific Interference measurement Region (NSIR) configuration message from a BS (S301).

The NSIR configuration message may be transmitted though a UE-specific higher layer signal. For example, the NSIR configuration message may be transmitted though an RRC message transmitted to specific UE. The NSIR configuration message may notify UE in which the specific node set is configured as a cooperative node set of an interference measurement region applied to all the nodes within the specific node set, that is, an NSIR. Each of the nodes within the node set performs muting in the NSIR. Accordingly, the NSIR configuration message may also be represented as providing notification of a node set-specific zero power CSI-RS configuration.

The BS sends a UE-specific CSI-RS configuration message to the UE (S302). The UE-specific CSI-RS configuration message is information that provides notification of a CSI-RS configuration for each piece of UE. The CSI-RS configuration may include a zero power CSI-RS configuration and a non-zero power CSI-RS configuration. In particular, the interference node of the UE may notify a resource region in which an NZP CSI-RS is transmitted through the UE-specific CSI-RS configuration message.

The UE measures interference outside the node set in the NSIR (S303) and measures interference from the interference node in the resource region in which the interference node sends a Non-Zero Power (NZP) CSI-RS (S304). The interference from the interference node may be said to be interference inside the node set.

The UE adds the interference outside the node set and the interference of the interference node (S305) and feeds the results back to the BS (S306).

In the above example, the UE has been illustrated as feeding the total amount of interference, that is, the sum of the interference outside the node set and the interference of the interference node, that is, the interference inside the node set, back to the BS, but the present invention is not limited thereto. That is, the UE may use the total amount of interference to compute a CQI and feed the computed CQI back to the BS.

In the CQI value computation process, a process of calculating the amount of a received signal through the NZP CSI-RS of a serving node or the node set configured in the process S302 may be added. In the process S306, a CQI value, that is, a value fed back to the BS, may be replaced with one or more of the total amount of interference, a total amount of interference inside a cell, a total amount of interference outside the cell, the amount of interference for each node, reception power for each node, and reception power for each NZP CSI-RS resource.

In the present embodiment, an example in which an NSIR configuration message and a UE-specific CSI-RS configuration message are separately transmitted has been illustrated, but the present invention is not limited thereto. That is, the NSIR configuration message may be included in a UE-specific CSI-RS configuration message and transmitted. That is, an NSIR may be indicated by adding an additional field to an existing UE-specific CSI-RS configuration message.

In an existing interference measurement method based on a CSI-RS, a zero power CSI-RS was configured in a UE-specific way. Accordingly, there was a problem in that muting resource overhead is excessively increased because muting resources are differently configured in order to measure interference from other nodes depending on a serving node combination of each price of UE.

In contrast, in the present invention, an NSIR in which all nodes within a node set may perform muting and measure interference outside the node set is configured in the state in which the node set has been configured to specific UE. Furthermore, a node that gives interference performs interference measurement (estimation) in an RE in which the node sends a non-zero power CSI-RS by taking interference from a node within a node set. Such interference measurement (estimation) results from the interference node are added to the measurement results of interference outside the node set and are fed back to a BS. Assuming that the number of nodes is N, at least one to a maximum of N muting resources have only to be given in each node for estimating interference from a node within a node set. Accordingly, muting resources are significantly reduced as compared with a conventional method.

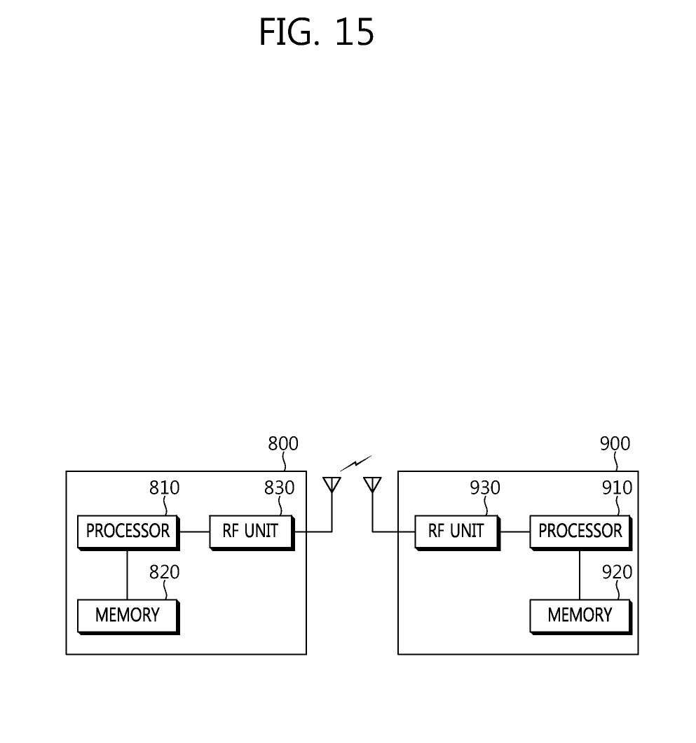

FIG. 15 is a block diagram of a wireless communication system in which an embodiment of the present invention is implemented.

A BS 800 includes a processor 810, memory 820, and a Radio Frequency (RF) unit 830. The processor 810 implements the proposed functions, processes and/or methods. The layers of a radio interface protocol may be implemented by the processor 810. The memory 820 is connected to the processor 810 and stores various pieces of information for driving the processor 810. The RF unit 830 is connected to the processor 810 and sends and/or receives radio signals.

UE 900 includes a processor 910, memory 920, and an RF unit 930. The processor 910 implements the proposed functions, processes and/or methods. The layers of a radio interface protocol may be implemented by the processor 910. The memory 920 is connected to the processor 910 and stores various pieces of information for driving the processor 910. The RF unit 930 is connected to the processor 910 and sends and/or receives radio signals.

The processor 810, 910 may include Application-Specific Integrated Circuits (ASICs), other chipsets, logic circuits and/or data processors. The memory 820, 920 may include Read-Only Memory (ROM), Random Access Memory (RAM), flash memory, memory cards, storage media and/or other storage devices. The RF unit 830, 930 may include a baseband circuit for processing radio signals. When the above-described embodiment is implemented in software, the above-described scheme may be implemented as a module (process or function) that performs the above function. The module may be stored in the memory 820, 920 and executed by the processor 810, 910. The memory 820, 920 may be placed inside or outside the processor 810, 910 and may be connected to the processor 810, 910 using a variety of well-known means.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

What is claimed is:

1. A method of measuring, by User Equipment (UE), interference in a multi-node system comprising a plurality of nodes, the method comprising:
receiving a Node set-Specific Interference measurement Region (NSIR) configuration message from a base station in a node set comprising some of the plurality of nodes, and
measuring interference in a resource region indicated by the NSIR configuration message,
wherein the NSIR configuration message comprises information for configuring an interference measurement region in which all the nodes within the node set send a zero power Channel State Information (CSI) Reference Signal (RS).

2. The method of claim 1, wherein the NSIR configuration message is received through a higher layer signal specific to the UE.

3. The method of claim 1, wherein the zero power CSI-RS is a reference signal whose transmission power is set to 0.

4. The method of claim 1, wherein the interference measured in the interference measurement region is a resource region in which interference outside the node set that is influenced by the UE from the outside of the node set is measured.

5. The method of claim 4, further comprising receiving a UE-specific SI-RS configuration message, wherein the UE-specific CSI-RS configuration message is information providing notification of a resource region of a non-zero power CSI-RS that needs to be measured by the UE.

6. The method of claim 5, wherein the resource region of the non-zero power CSI-RS comprises a resource region in which interference inside the node set due to a node within the node set that gives interference to the UE is measured.

7. The method of claim 6, wherein nodes other than the node that gives interference to the UE and that belongs to the node set sends the zero power CSI-RS in the resource region of the non-zero power CSI-RS.

8. The method of claim 6, wherein a Channel Quality Indicator (CQI) is computed based on a total amount of interference that is a sum of the interference inside the node set and the interference outside the node set, and the computed CQI is fed back to the base station.

9. The method of claim 6, wherein at least one of the interference inside the node set, the interference outside the node set, and the total amount of interference that is the sum of the interference inside the node set and the interference outside the node set is fed back to the base station.

10. User Equipment (UE) measuring interference in a multi-node system comprising a plurality of nodes, the UE comprising:
a Radio Frequency (RF) unit sending or receiving radio signals; and
a processor connected to the RF unit,
wherein the processor receives a Node set-Specific Interference measurement Region (NSIR) configuration message from a base station in a node set comprising some of the plurality of nodes and measures interference in a resource region indicated by the NSIR configuration message, and
the NSIR configuration message comprises information for configuring an interference measurement region in which all the nodes within the node set send a zero power Channel State Information (CSI) Reference Signal (RS).

11. The UE of claim 10, wherein the NSIR configuration message is received through a higher layer signal specific to the UE.

12. The UE of claim 10, wherein the interference measured in the interference measurement region is a resource region in which interference outside the node set that is influenced by the UE from the outside of the node set is measured.

13. The UE of claim 12, further comprising receiving a UE-specific SI-RS configuration message, wherein the UE-specific CSI-RS configuration message is information providing notification of a resource region of a non-zero power CSI-RS that needs to be measured by the processor.

14. The UE of claim 13, wherein the resource region of the non-zero power CSI-RS comprises a resource region in which interference inside the node set due to a node within the node set that gives interference to the UE is measured.

15. The UE of claim 14, wherein nodes other than the node that gives interference to the UE and that belongs to the node set sends the zero power CSI-RS in the resource region of the non-zero power CSI-RS.

16. The UE of claim 14, wherein a Channel Quality Indicator (CQI) is computed based on a total amount of interference that is a sum of the interference inside the node set and the interference outside the node set, and the computed CQI is fed back to the base station.

17. The UE of claim 14, wherein at least one of the interference inside the node set, the interference outside the node set, and the total amount of interference that is the sum of the interference inside the node set and the interference outside the node set is fed back to the base station.
